(19) United States
(12) Patent Application Publication
(10) Pub. No.: US 2014/0286487 A1
(43) Pub. Date: Sep. 25, 2014

(54) METHOD FOR GENERATING A ONE-WAY FUNCTION

(71) Applicants: Eberhard BOEHL, Reutlingen (DE); Klaus DAMM, Reutlingen (DE)

(72) Inventors: Eberhard BOEHL, Reutlingen (DE); Klaus DAMM, Reutlingen (DE)

(73) Assignee: ROBERT BOSCH GMBH, Stuttgart, DE (DE)

(21) Appl. No.: 14/222,211

(22) Filed: Mar. 21, 2014

(30) Foreign Application Priority Data
Mar. 22, 2013 (DE) 10 2013 205 166.2

(51) Int. Cl. G06F 21/60

(52) U.S. Cl. CPC G06F 21/602
USPC 380/28

(57) ABSTRACT

A method for generating a one-way function, as well as a circuit arrangement, which implements the one-way function, are set forth.

### FIELD OF THE INVENTION

The present invention relates to a method for generating a one-way function for a cryptographic method, and to a circuit arrangement. This circuit arrangement is used, in particular, for implementing or realizing the one-way function.

### BACKGROUND INFORMATION

A one-way function is a mathematical function, which is “easily” calculable, but “difficult” to invert. Cryptographic one-way functions are needed, in order that, from generated data, an attacker may not calculate, or, in some instances, may only calculate with unjustifiable expenditure, an internal state, input data used, or data previously outputted. Such a procedure is also referred to as backtracking.

Normally, multiplications, the Rabin function (x² mod N), discrete exponential functions or hash functions are used for such one-way functions. Carry-less multiplication may also be used, as is described, for example, in United States Published Patent Appin. No. 20 1001 257 28 A1. In this context, use is made of the fact that multiplication may be carried out simply, but the inverse operation or factorization becomes complicated, since, in particular, several options are available. This variety is even increased, when an amount carried over is not used or a modulo N function is used, as in the case of the Rabin function.

The multiplication alone, without carryover or modulo x, does not provide, especially for operands having a low bit width, the necessary level of complication and nonlinearity for some applications.

The method put forth is used in the production of a random output bit sequence, and is consequently used for generating random numbers. Random numbers, which are referred to as the result of random elements, are needed for many applications. So-called random number generators are used for generating random numbers. Random number generators are methods, which supply a sequence of random numbers. A decisive criterion of random numbers is whether the result of the generation can be regarded as independent of earlier results.

In order to generate random bit sequences, random bit generators are used, which deliver a random output bit sequence in response to the inputting of an input bit sequence.

Random numbers are needed, e.g., for cryptographic methods. These random numbers are used, in order to generate keys for the encryption methods. Strict requirements regarding the random characteristics are placed on such keys.

In particular, the amount, that is, the measure of chance, namely, entropy per bit, has to be sufficient. In addition, the bit probabilities for the values from {0, 1} should be equally likely. It should be noted that the random values generated for this by known random number sources mostly do not satisfy these requirements. Therefore, additional methods are necessary, which are combined under the term post processing. A DRGB (deterministic random bit generator), as is described, for example, by the Bundesamt fur Sicherheit in der Informationstechnik (Federal Office for Security in Information Technology) (BSI) in BSI AIS 31 of Sep. 25, 2001, is typically used for such post processing. Such a generator produces deterministic bit sequences, which, however, appear random. Such generators are also referred to as pseudo-random number generators. If an unknown seed is used as a starting point for the pseudo-random sequence, then this sequence cannot be predictable, even when one knows the bits of the pseudo-random sequence already outputted, but not the seed.

In this connection, the characteristics of a DRBG are being studied more closely, and there are recommendations for a DRBG from the National Institute of Standards and Technology (NIST), in a Special Paper, NIST SP 800-90 from March, 2007.

The post processing of the related art is typically carried out, using resilient functions (elastic functions), linear feedback shift registers (LFSR's) and multiple input LFSR's or MISR's (multiple input signature registers).

Methods of the related art are either very expensive, such as resilient functions, or they do not exactly satisfy the 50% bit probabilities, such as LFSR's. In addition, the two methods mentioned above do not have the possibility of recognizing errors in the sequence, which may be caused, e.g., by error attacks.

### SUMMARY

Against this background, a method and a circuit arrangement are put forth. By combining the upper half of the result bits of a multiplication with the lower half, and thus, the less significant half, as a function of the value ratio of these two parts and of the special function for operands having a value of 0, a balanced look-up table may be obtained, which may be implemented as a ROM version via table values, but also simply with the aid of a combinatorial circuit.

The circuit arrangement put forth may be used for implementing a one-way function within the scope of a method for generating a random output bit sequence, which method will be discussed in detail in the following.

To this end, a method for generating a pseudo-random output bit sequence is initially put forth, in which a set-up of 2ⁿ finite state machines, each of which is identically constructed, is used; the finite state machines each including n status bits; each finite state machine always assuming a different state from the other finite state machines of the set-up; on the input side, the finite state machines each being supplied an identical input signal, and as a function of their state, these each generating n signature bits, which together form a signature bit sequence; and the random output bit sequence being generated by selecting individual bits from the signature bit sequences of all of the finite state machines of the set-up.

The method is carried out, for example, using a pseudo-random bit generator for generating a random output bit sequence having an unknown seed; the pseudo-random bit generator including a set-up of 2ⁿ finite state machines, each of which are identically constructed; the finite state machines each including n status bits; each always assuming a different state from the other finite state machines of the set-up; on the input side, the finite state machines having to be supplied an input signal, and as a function of their state, these each generating n signature bits, which together form a signature bit sequence; and the random output bit sequence being generated by selecting individual bits from the signature bit sequences of all of the finite state machines of the set-up.

In comparison with known methods, the method has the possibility of recognizing error attacks. In addition, it provides a better bit probability than an LFSR. However, this method has the disadvantage that collisions may occur, that is, identical output sequences may occur from different input bit sequences. Attacks of an attacker may be aided by such collisions. In addition, in the method, it is more easily possible to retrace the outputted output signals than in the method, which will now be set forth below.

The method explained above is now expanded, such that the inputs are processed twice, and namely, that they first go directly into the set-up of finite state machines, which is also referred to as a COSSMA set-up (complete set of state machines), and that in addition, they go into it linked with a one-way function.

Direct input ensures that no entropy is lost during processing, and the second linked input helps to prevent collisions, makes retracing or backtracking, that is, calculation of previous output values, more difficult, and makes prediction of future output values more difficult, when the seed is unknown. One may also dispense with direct input, when it can be proven that no entropy is lost in response to linkage with the one-way function, and that the collisions also do not occur more often, due to it.

In addition, the effect of all input bits on the output value may be equalized, when a parity is also calculated after the processing of the last input bit and is reflected in the output value.

Additional advantages and embodiments of the present invention are derived from the description and the appended figures.

It will be appreciated that the features mentioned above and the features yet to be described below may be used not only in the combination given in each case, but also in other combinations or individually, without departing from the scope of the present invention.

### BRIEF DESCRIPTION OF THE DRAWINGS

FIG. 1 shows a one-way function.

FIG. 2 shows the set-up of a variant of the method put forth.

FIG. 3 shows a specific embodiment of the described device for implementing the described method.

FIG. 4 shows a set-up of finite state machines.

FIG. 5 shows a 4-bit finite state machine.

FIG. 6 shows state transitions.

FIG. 7 shows a DRBG output stage.

### DETAILED DESCRIPTION

The present invention is represented schematically in the drawings in light of specific embodiments, and is described in detail below with reference to the drawing.

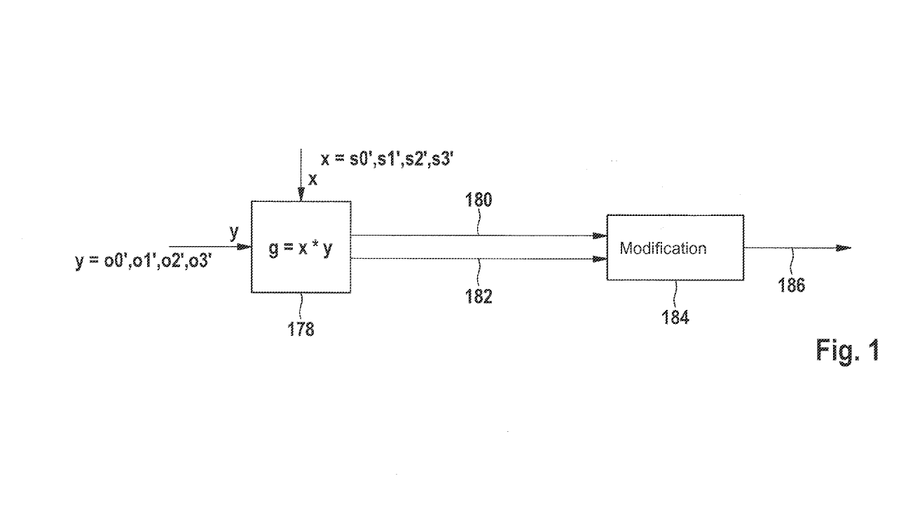

FIG. 1 illustrates a one-way function g=x*y including an input nibble x and feedback of intermediate output y as input variables. This produces a higher nibble 180 of g and a lower nibble 182 of g, which are subjected to a modification 184 so as to obtain a result 186.

As illustrated in FIG. 1, the one-way function is achieved by multiplying two operands. The result of this operation typically has the double bit width, which may be divided up into two partial results including the single bit width in upper bits and lower bits. It should be noted that it may be necessary to restore this double bit width to the single bit width. To this end, the numerical values of the two partial results are compared to one another and are variably combined as a function of the comparison result. To that end, in the exemplary embodiment, operands each having 4 bits are considered, and the lower and upper nibble of the result are compared before the two are combined with one another. Special operations not including multiplication are used for the case, in which one or the two operands are equal to zero. If an operand is zero, the other operand is generated as a negative value, but without the algebraic sign, and the value of 2 is added to this value. The negative value corresponds to the double complement of the operand, which is obtained by inverting all of the bits and subsequently incrementing them. The resulting value may also be calculated by inverting all of the bits of the operand and adding the value 3 to them. This is a summary of the incrementation by addition of 2. In these addition operations, the amounts to be carried over are disregarded. If both operands are zero, then a defined value is outputted. In the variant described, the value 2 is used for it. Using these operations, one obtains the uniform distribution of all possible values in Table 1 for all rows and columns. If the two operands are not zero, the higher 4 bits are subtracted from the lower 4 bits, and either a 1 or a 2 is added, depending on whether or not the less significant nibble is greater than the higher significant nibble. In this case as well, a two-complement representation is used for the operands in the event of negative values.

It may be provided that for the case in which a first operand is zero, only the value of the second operand be modified according to an established rule and this modification be selected in such a manner, that for any arbitrary second operand, all possible values, including zero, occur when the second operand is varied, such that all possible values, including zero, are assumed.

Table 1 depicts a result table, which represents a one-way function:

TABLE 1

| x/y | 0 | 1 | 2 | 3 | 4 | 5 | 6 | 7 | 8 | 9 | a | b | c | d | e | f |
|---|---|---|---|---|---|---|---|---|---|---|---|---|---|---|---|---|
| 0 | 2 | 1 | 0 | 15 | 14 | 13 | 12 | 11 | 10 | 9 | 8 | 7 | 6 | 5 | 4 | 3 |
| 1 | 1 | 2 | 3 | 4 | 5 | 6 | 7 | 8 | 9 | 10 | 11 | 12 | 13 | 14 | 15 | 0 |
| 2 | 0 | 3 | 5 | 7 | 9 | 11 | 13 | 15 | 1 | 2 | 4 | 6 | 8 | 10 | 12 | 14 |
| 3 | 15 | 4 | 7 | 10 | 13 | 0 | 2 | 5 | 8 | 11 | 14 | 1 | 3 | 6 | 9 | 12 |
| 4 | 14 | 5 | 9 | 13 | 1 | 4 | 8 | 12 | 0 | 3 | 7 | 11 | 15 | 2 | 6 | 10 |
| 5 | 13 | 6 | 11 | 0 | 4 | 9 | 14 | 2 | 7 | 12 | 1 | 5 | 10 | 15 | 3 | 8 |
| 6 | 12 | 7 | 13 | 2 | 8 | 14 | 3 | 9 | 15 | 4 | 10 | 0 | 5 | 11 | 1 | 6 |
| 7 | 11 | 8 | 15 | 5 | 12 | 2 | 9 | 0 | 6 | 13 | 3 | 10 | 1 | 7 | 14 | 4 |
| 8 | 10 | 9 | 1 | 8 | 0 | 7 | 15 | 6 | 14 | 5 | 13 | 4 | 12 | 3 | 11 | 2 |
| 9 | 9 | 10 | 2 | 11 | 3 | 12 | 4 | 13 | 5 | 14 | 6 | 15 | 7 | 0 | 8 | 1 |
| a | 8 | 11 | 4 | 14 | 7 | 1 | 10 | 3 | 13 | 6 | 0 | 9 | 2 | 12 | 5 | 15 |
| b | 7 | 12 | 6 | 1 | 11 | 5 | 0 | 10 | 4 | 15 | 9 | 3 | 14 | 8 | 2 | 13 |
| c | 6 | 13 | 8 | 3 | 15 | 10 | 5 | 1 | 12 | 7 | 2 | 14 | 9 | 4 | 0 | 11 |
| d | 5 | 14 | 10 | 6 | 2 | 15 | 11 | 7 | 3 | 0 | 12 | 8 | 4 | 1 | 13 | 9 |
| e | 4 | 15 | 12 | 9 | 6 | 3 | 1 | 14 | 11 | 8 | 5 | 2 | 0 | 13 | 10 | 7 |
| f | 3 | 0 | 14 | 12 | 10 | 8 | 6 | 4 | 2 | 1 | 15 | 13 | 11 | 9 | 7 | 5 |

This assignment, which is to be taken from Table 1, ensures that every output occurs 16 times. For this, reference is made to Table 2. This shows a statistic for transforming Table 1, as the frequency of every value is indicated. An additional characteristic of Table 1 is that in every row and column, each value occurs exactly once.

TABLE 2

| | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |
| 16 | 16 | 16 | 16 | 16 | 16 | 16 | 16 | 16 | 16 | 16 | 16 | 16 | 16 | 16 | 16 |

The complexity of this transformation may be determined, when each individual result bit is illustrated after the transformation via a Boolean equation, which is referred to as algebraic normal form ANF, and which consists of the antivalent combination XOR of conjunctive terms AND.

Table 3 shows the combined results of evaluating these equations and is the result of a complexity analysis of the individual bit functions of the overall result for a fixed operand.

TABLE 3

| Operand/ | | | | | all 4 bits |
|---|---|---|---|---|---|
| Bit | MSB (d) | MSB-1 (c) | MSB-2 (b) | LSB (a) | (summarily) |
| 0 | simple 4 | complex 3 | complex 4 | simple 1 | complex 4 |
| 1 | complex 4 | complex 4 | complex 4 | simple 1 | complex 4 |
| 2 | simple 4 | simple 4 | simple 4 | simple 4 | simple 4 |
| 3 | complex 4 | complex 4 | complex 4 | complex 4 | complex 4 |
| 4 | complex 4 | complex 4 | simple 4 | complex 4 | complex 4 |
| 5 | complex 4 | complex 4 | complex 4 | complex 4 | complex 4 |
| 6 | complex 4 | complex 4 | complex 4 | complex 4 | complex 4 |
| 7 | complex 4 | complex 4 | complex 4 | complex 4 | complex 4 |
| 8 | complex 4 | complex 4 | complex 4 | simple 2 | complex 4 |
| 9 | complex 4 | complex 4 | simple 4 | simple 2 | complex 4 |
| a | complex 4 | complex 4 | complex 4 | complex 4 | complex 4 |
| b | complex 4 | complex 4 | complex 4 | complex 4 | complex 4 |
| c | complex 4 | complex 4 | complex 4 | complex 4 | complex 4 |
| d | complex 4 | complex 4 | simple 4 | simple 3 | complex 4 |
| e | complex 4 | complex 4 | complex 4 | complex 4 | complex 4 |
| f | simple 2 | simple 1 | simple 4 | simple 3 | simple 4 |

In this context, a function is rated as complex, when the ANF contains at least two conjunctive terms having at least two variables each; otherwise, they are rated as simple. The number generally indicates, on how many variables the function depends altogether. In summary, it may be ascertained that each bit function by itself is only rated as simple for the fixed operands 0x2 and 0xf.

However, the totality of all 4 bits is always a function of all 4 bits, and all 4 bits have, altogether, approximately the same influence on the overall function. In addition, it should be noted that there is a weakness in the two mentioned operands that has to be taken into consideration. This weakness is, for example, the non-complex function in the case of the operands 0x2 and 0xf. If these operands (0x2 or 0xf) are to be prevented from occurring at above-average numbers in the case of repeated use, one may accept this weakness, in particular, when the one-way function is used several times for generating an output function.

In principle, the selection of the modification according to FIG. 1 may be made a function of different characteristics of the partial results. Such results may include:

a) the ratio of the decimal value of the partial results, as is shown in FIG. 1;

b) the ratio of the number of ones of the partial results;

c) the ratio of the maximum number of linked ones in the partial results;

d) the ratio of the maximum number of linked zeroes in the partial results.

In this manner, a selection may be made as to whether the partial results are added or subtracted, and whether or not a value is added. The selected operation is chosen from the ratio of the characteristics of the partial results to one another.

The explained function may be implemented in a simple manner as a combinatorial circuit, for example, by setting up a VHDL description and synthesizing it.

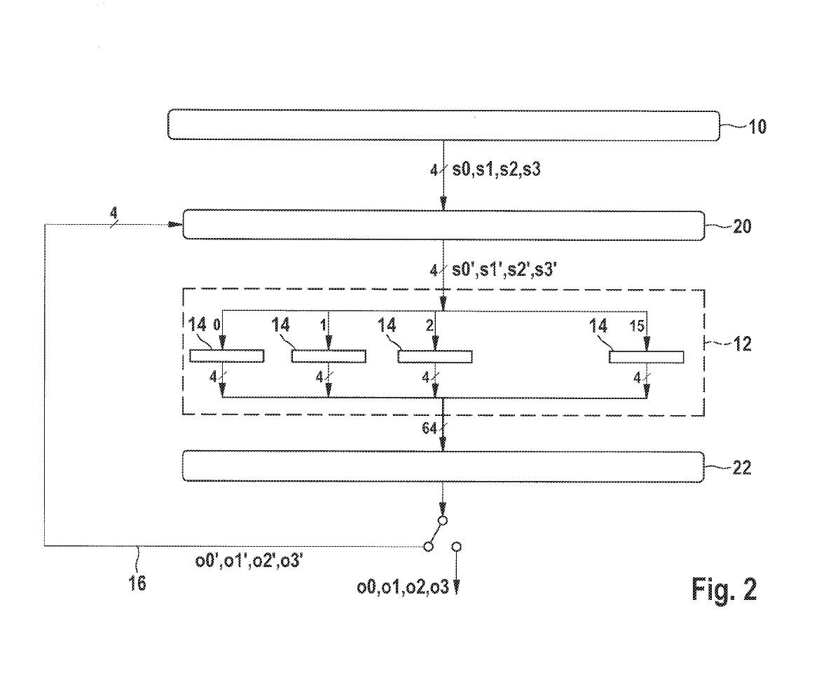

The use of a one-way function in generating a random output bit sequence is explained below with the aid of FIGS. 2 through 7.

As illustrated in FIG. 2, in a first step 10, 4 output bits s0, s1, s2, s3 are generated, in each instance, on the basis of 64 input bits, which are referred to as a seed. This seed is predefined and may be, for example, the output of a TRNG source. After the 4 output bits are calculated, this seed is increased by one by a built-in incrementer, and this incremented seed is used for generating the next 4 output bits. This procedure is continued until a new seed is selected. In the first step, the first 4 bits are initially selected from the 64-bit input and immediately applied to the finite-state machine set-up 12 having sixteen finite state machines 14.

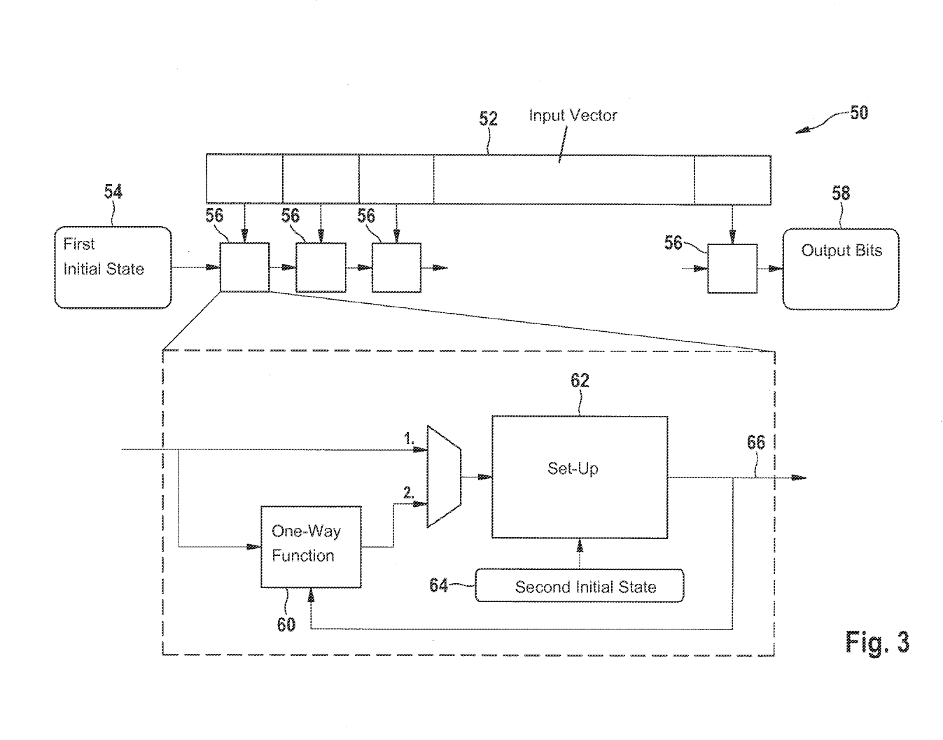

The function of the finite-state machine set-up is explained in FIGS. 3, 4 and 5.

FIG. 3 shows a lay-out of a device for implementing the method, the overall device being designated by reference numeral 50. The illustration shows, as an input, an input vector 52, which is subdivided into blocks of 4 bits, a first initial state 54, which resets internal counters of the set-up that become operative for the selection of output bits 58 in connection with the values of input vector 52. In addition, the illustration shows a one-way function 60, a set-up 62 of finite state machines (COSSMA), on which a second initial state 64 acts, which either is active prior to each new processing of an input vector 52 or also first determines the initial state of the finite state machines present in set-up 62 after a predetermined number of input vectors 52. Consequently, after processing the input twice, a value is produced at output 66 of set-up 62.

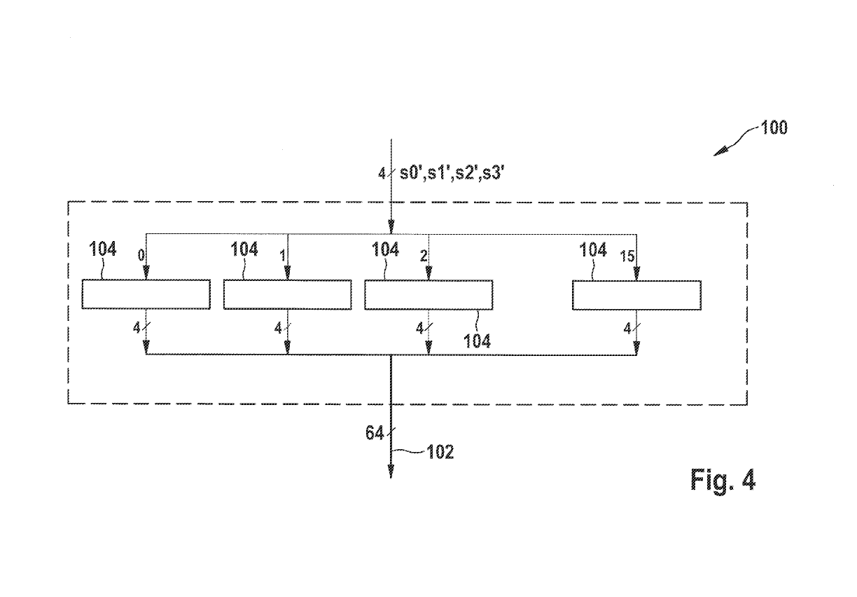

FIG. 4 illustrates a set-up of finite state machines, which is designated, altogether, by reference numeral 100, and which is also referred to as a complete set of finite state machines (COSSMA: COmplete Set of State MAchines). Thus, FIG. 3 shows a complete set of finite state machines corresponding to set-up 12 in FIG. 2.

This set-up 100 has a 4-bit input s0′, s1′, s2′, s3′ and a 64-bit output 102. The bits of output 102 are forced by flipflops of finite state machines 104.

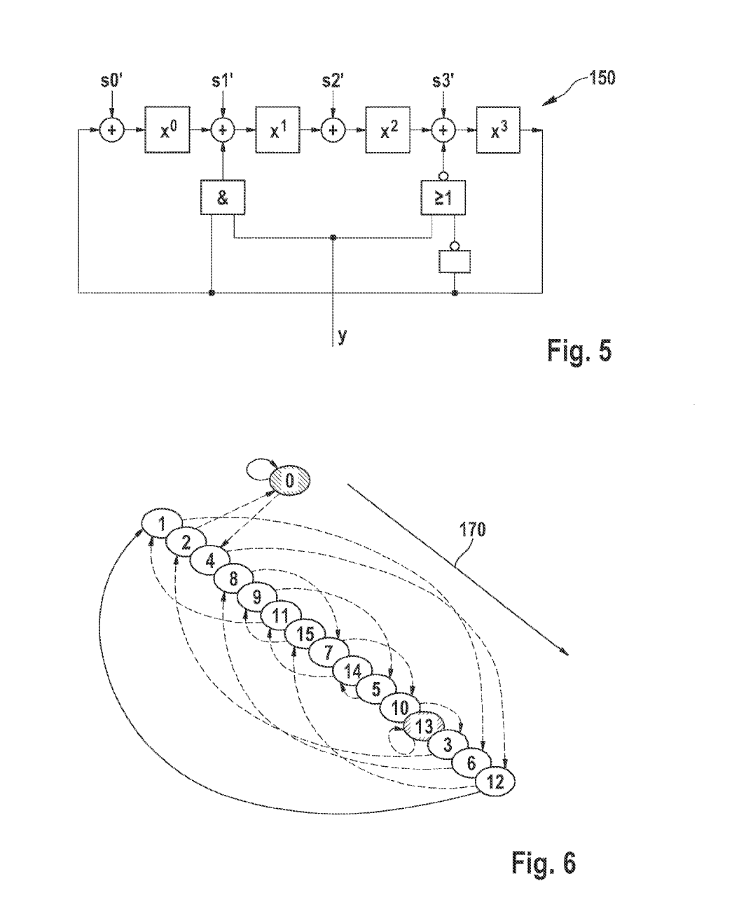

FIG. 5 shows a 4-bit finite state machine, which is designated by reference numeral 150 and is implemented in the form of a 4-bit NLMISR (non-linear multiple input signature register).

Any finite state machine may also be used in place of the NLMISR from FIG. 5, when in each instance, the follow-up state and the predecessor state are uniquely determined for any selected input sequence.

The transfer function of the circuit from FIG. 5 is indicated in the following table.

| Follow-up State of the Flipflop xi | Equation |
|---|---|
| x⁰ | = s′(0)⊕ x³ |
| x¹ | = s′(1) ⊕ x⁰⊕yx³ |
| x² | = s′(2)⊕ x¹ |
| x³ | = s′(3) ⊕ x² ⊕/yx³ |

The input bits of all 16 NLMISR's are, in each instance, identical. However, their initial state is different. Thus, according to the aforementioned condition, each NLMISR has, at each instant, a different state from every other NLMISR.

State transitions of the utilized finite state machines, when s0′=s1′=s3′=0, are illustrated in FIG. 6. A solid arrow shows a transition for s2′=0; in this case, a direct transition diagonally to the right, down below, via the respective intermediate states for, in each case, one clock pulse, also being possible, as indicated on the right by arrow 170. A dashed arrow stands for s2′=1.

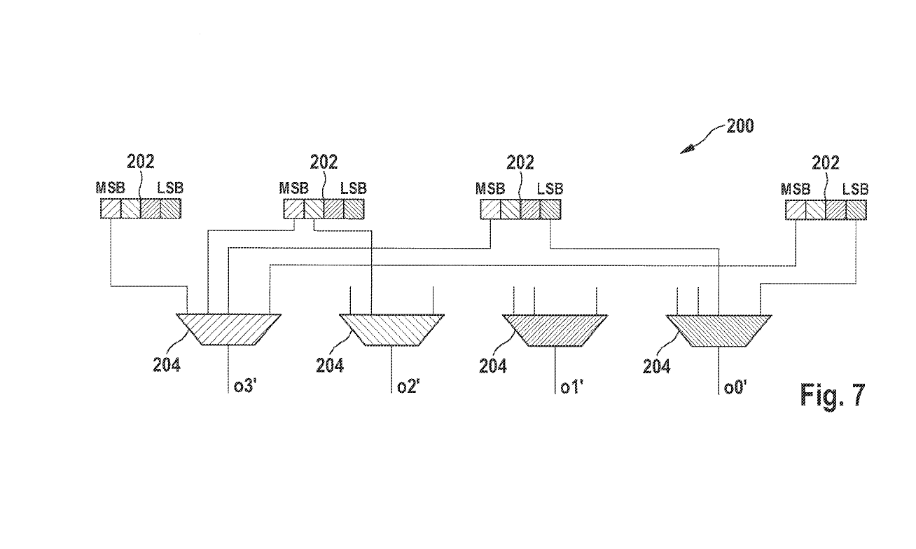

FIG. 7 shows a DRBG output stage, the whole of which is denoted by reference numeral 200. The illustration shows a series of finite state machines 202, which are connected to multiplexers 204. Output stage 200 delivers an intermediate output, which is used for feedback and a final output.

The present invention is explained below with the aid of the figures:

The distribution 0,1,2,3, . . . 15 may be selected as the initial state of finite-state machine set-up 12, 62, 100. It is important that every identically constructed finite state machine 14 have a different initial state. This initial state does not have to be secret, but it may also be treated as a secret state for special applications. A function is then available, which would be comparable to the so-called keyed hash functions that have additional, improved cryptographic characteristics.

In accordance with the input nibble s0, s1,s2, s3 used, for the first step 10 identical to s0′, s1′, s2′, s3′, and in accordance with the step number i=0, according to FIG. 2, the 4 internal counters z0 . . . z3 are determined, which determine a selection of 4 bits from finite state machines 202 from finite-state machine set-up 100 according to FIG. 4. In this context, finite-state machine set-up 100 has already been modified by the first input nibble in accordance with FIGS. 4 and 5. These 4 bits represent the intermediate output feedback values, which are clearly shown in FIG. 1, using the reference numeral 16. Using these values, after the first input step, in a second step 20, the same input nibble is modified by the one-way function, which is described in FIG. 1. This modification is defined in Table 1.

Using first input nibble s0, s1, s2, s3 as a first operand, and intermediate output o0′, o1′, o2′, o3′, which comes from an output stage 22 that makes a selection of 4 bits, as a second operand, one obtains, for the one-way function, the output: result=s0′, s1′, s2′, s3′, which differs from s0, s1, s2, s3 by a permutation according to Table 1. This output is applied to finite-state machine set-up 12. In this manner, all 64 input bits are each used twice, one after another, as nibbles, namely, without and with a one-way function.

In each instance, after a particular number of input steps, for example, 5, a parity step is inserted. Inputs si′ of the previous five input steps are used, in each instance, to form a serial parity, which is inserted in the following step. In the exemplary embodiment, an even parity is generated from LSB s0″, and an odd parity is generated for each of all of the other bits. The parity should be an odd parity for an odd number of input bits and an even parity for the remaining inputs. This is determined by the different initial state of the flipflops. By applying the parities to set-up 12, 62, 100, it is ensured that the switchover signal for the polynomial y (according to FIG. 5) differs at least once for these six steps.

The switchover signal is explained in greater detail, for example, in German Published Patent Appin. No. 10 2009 000 3221. This causes nonlinearity, since a different polynomial of the NLMISR is selected as a function of the input signals.

The insertion of a parity may also be omitted, if the one-way function has characteristics that render a changeover of the polynomial likely for any input sequences.

After all of the inputs have been processed, the intermediate outputs for three further steps are used directly as inputs for set-up 12, in order to finally still terminate the processing cycle of a 64-bit vector with a parity. If occasion arises, one may also dispense with these additional steps.

In each instance, the seed is incremented after the generation of a 4-bit output value o0, o1, o2, o3, after the processing of all 64 input bits, and using this modified seed, 4 additional bits are generated according to the same method. In each instance, after the generation of, e.g., a total of 128 output bits, the state of set-up 12, 62, 100 is reset to initial state 64. In contrast, the initial state 54 for selection counters z0 through z3, which are used for driving multiplexers 204 in FIG. 7, is advantageously assumed after each processing of an input vector 52. Instead of incrementing it, the seed may also be decremented, incremented according to a code table, translated, rotated or otherwise modified.

The state of set-up 12, 62, 100 may be checked using different methods. This is possible, since in set-up 12, 62, 100, every finite state machine has a different state at each instant. In addition, the method may be subjected to a test. The different states are ensured by the fact that at the beginning, all of the finite state machines are initialized to different starting values. Due to the substantially identical action of the inputs having a unique successor and predecessor, no equal state may be obtained in two finite state machines.

If the above-mentioned condition no longer applies due to an attack or due to a transient error, such as a soft error caused by cosmic radiation, then this error is detected and suitable measures may be taken, such as a reset.

In the method described above, any other one-way function may also be used in place of the described multiplication. Such one-way functions include, for example, the discrete exponential function, the Rabin function (x2 mod N) or a hash function.

In addition, one may dispense with inserting parities and also omit the three additional steps including a direct application of the intermediate outputs to set-up 12, 62, 100. This may be advantageous for applications having less strict requirements; the nonlinearity of the one-way function is possibly already sufficient for satisfying the corresponding requirements. It is also possible to avoid processing each input nibble twice and to supply only the signals generated by the one-way function to set-up 12, 62, 100.

The circuit arrangement described is used for generating a one-way function from two operands, which each include several bits with the aid of a multiplication operation. The result of the operation is divided into at least two parts, and these parts are each linked to a different function as a function of the ratio or the relation of the characteristics of these parts to one another, so that in the case in which an operand is zero, a function is generated from the other operands, and in the case in which both operands are zero, a predefined value is outputted.

The one-way function may be stored in a table, which is stored, in turn, in a memory array. As a function of the operand value, the corresponding memory location may be read and outputted.

Alternatively, the one-way function may be implemented by a circuit having logic elements.

What is claimed is:

1. A method for generating a one-way function for a cryptographic function, comprising:
performing an operation on two operands;
dividing up a result of the operation into two partial results;
comparing the two partial results to each other; and
combining the two partial results with one another as a function of the comparing.

2. The method as recited in claim 1, wherein the operation includes a multiplication of at least the two operands.

3. The method as recited in claim 2, wherein in the case in which the two operands are zero, a defined value is outputted.

4. The method as recited in claim 1, wherein:
in the case in which a first operand is zero, only a value of a second operand is modified according to a predetermined rule,
the modification is selected such that for any arbitrary, second operand, all possible values occur when the second operand is varied in such a manner, that all possible values are assumed.

5. The method as recited in claim 1, wherein:
an operation is carried out on at least two operands, and
for any fixed value of a first operand, a second operand is able to be selected in such a manner, that any possible value of the result may be obtained.

6. The method as recited in claim 1, further comprising:
generating a table that represents the one-way function; and
storing the table in a memory array.

7. The method as recited in claim 1, wherein the one-way function is implemented by an electronic circuit arrangement.

8. The method as recited in claim 1, wherein a weakness of the operands is taken into consideration.

9. A circuit arrangement for generating a one-way function for a cryptographic function, comprising:
an arrangement for performing an operation on two operands;
an arrangement for dividing up a result of the operation into two partial results;
an arrangement for comparing the two partial results to each other; and
an arrangement for combining the two partial results with one another as a function of the comparing.

10. The circuit arrangement as recited in claim 9, wherein the circuit arrangement includes a combinatory logic circuit.
